(19) United States
(12) Patent Application Publication
(10) Pub. No.: US 2013/0148372 A1
(43) Pub. Date: Jun. 13, 2013

(54) LIGHT GUIDE DEVICE FOR VEHICLE

(71) Applicant: TYC Brother Industrial Co., Ltd., Tainan (TW)

(72) Inventors: Ming-Jhih SHIH, Tainan (TW); Jin-Hua WU, Tainan (TW); Yi-Da CHIU, Tainan (TW)

(73) Assignee: TYC BROTHER INDUSTRIAL CO., LTD., Tainan (TW)

(21) Appl. No.: 13/692,176

(22) Filed: Dec. 3, 2012

(30) Foreign Application Priority Data
Dec. 12, 2011 (TW) 100145821

(51) Int. Cl. B60Q 1/00

(52) U.S. Cl. CPC B60Q 1/00
USPC 362/511

(57) ABSTRACT

The invention provides a light guide device for vehicle, including at least one incident portion, a diffusion surface and a reflective portion. The at least one incident portion is disposed on at least one end of the light guide device, and is used to receive at least one light source. The diffusion surface is used to export light, and the diffusion surface has a plurality of zigzag structures. The reflective portion is opposite to the diffusion surface, and is used to reflect light to the diffusion surface. The incident portion is disposed between the diffusion surface and the reflective portion. Therefore, by using the light guide device, light can be fully reflected in the light guide device, and light is exported by the diffusion surface. Thus, no light will leak to the outside through the reflective portion, thereby greatly increasing light guiding efficiency of the light guide device.

### BACKGROUND OF THE INVENTION

1. Field of the Invention

The present invention relates to a light guide device, and more particularly to a light guide device for vehicle.

2. Description of the Related Art

FIG. 1 shows a schematic view of a conventional light guide device for vehicular lamps. The conventional light guide device 10 includes a first adjacent surface 11, a second adjacent surface 12, a light-emitting surface 13, a diffusing portion 14 and two defocus surfaces 15, 16.

The first adjacent surface 11 and the second adjacent surface 12 are disposed at two ends of the conventional light guide device 10, and used to receive a light source 17. The light-emitting surface 13 is used to export light. The diffusing portion 14 is disposed opposite the light-emitting surface 13, and has a plurality of zigzag structures 141 used to guide light to the light-emitting surface 13. Two defocus surfaces 15, 16 are connected between the light-emitting surface 13 and the diffusing portion 14, respectively.

When the light of the light source 17 transmit to the diffusing portion 14, part of the light from the diffusing portion 14 transmit to the light-emitting surface 13, and another part of the light directly transmit to the outside through the diffusing portion 14. Therefore, the conventional light guide device 10 has low emitting and guiding efficiency.

Therefore, it is necessary to provide a light guide device to solve the above problems.

### SUMMARY OF THE INVENTION

The present invention provides a light guide device for vehicle. The light guide device of the invention includes at least one incident portion, a diffusion surface and a reflective portion. The at least one incident portion is disposed on at least one end of the light guide device, and is used to receive at least one light source. The diffusion surface is used to export light, and the diffusion surface has a plurality of zigzag structures. The reflective portion is opposite to the diffusion surface, and is used to reflect light to the diffusion surface. The at least one incident portion is disposed between the diffusion surface and the reflective portion.

Therefore, by using the light guide device of the present invention, light can be fully reflected in the light guide device, and light is exported by the diffusion surface. By disposing the reflective portion and correspondingly disposing the diffusion surface, light directly from the light source or light reflected by the diffusion surface to the reflective portion can be reflected to the diffusion surface through the reflective portion again, so no light will leak to the outside through the reflective portion, thereby greatly increasing light guiding efficiency of the light guide device of the present invention.

### BRIEF DESCRIPTION OF THE DRAWINGS

FIG. 1 shows a schematic view of a conventional light guide device for vehicular lamps;

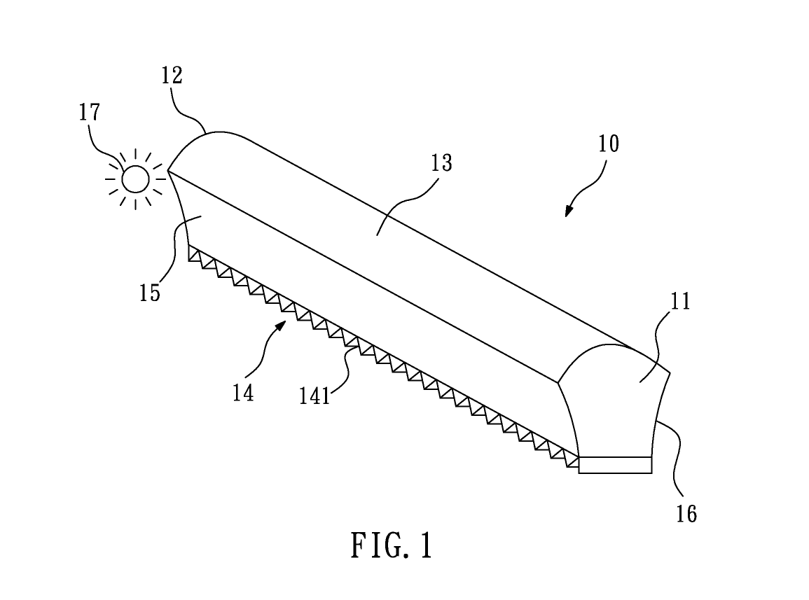

FIG. 2 shows a schematic view of a light guide device for vehicle according to a first embodiment of the present invention;

FIG. 3 shows a schematic view of a light guide device for vehicle according to a second embodiment of the present invention;

FIG. 4 shows a schematic view of a light guide device for vehicle according to a third embodiment of the present invention; and

FIG. 5 shows a schematic view of a light guide device for vehicle according to a fourth embodiment of the present invention.

### DETAILED DESCRIPTION OF THE INVENTION

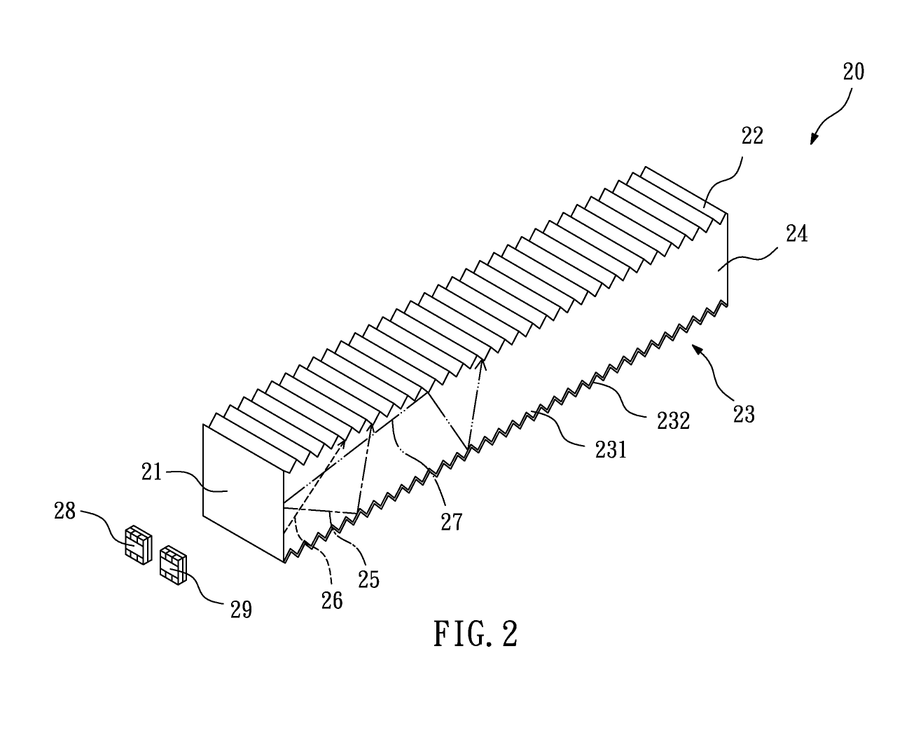

Referring to FIG. 2, it shows a schematic view of a light guide device for vehicle according to a first embodiment of the present invention. According to the first embodiment of the present invention, the light guide device 20 includes: at least one incident portion 21, a diffusion surface 22 and a reflective portion 23. The at least one incident portion 21 is disposed on at least one end of the light guide device 20, and is used to receive at least one light source 28, 29. In this embodiment, the light sources 28, 29 are light emitting diodes (LED), and are disposed at the at least one incident portion 21.

The diffusion surface 22 is used to export light, and the diffusion surface 22 has a plurality of zigzag structures. The reflective portion 23 is opposite to the diffusion surface 22, and is used to reflect light to the diffusion surface 22. The at least one incident portion 21 is disposed between the diffusion surface 22 and the reflective portion 23, that is, the at least one light source 28, 29 is disposed between the diffusion surface 22 and the reflective portion 23.

In this embodiment, the reflective portion 23 includes a zigzag portion 231 and a reflective surface 232, the zigzag portion 231 has a plurality of zigzag structures, the reflective surface 232 is formed at surfaces of the zigzag structures, and the reflective surface 232 is an electroplating surface. Preferably, the electroplating surface is an electroplating aluminum surface.

After light is emitted from the light sources 28, 29, for example, a first optical path 25 is irradiated by the light source to the reflective surface 232, and is reflected by the reflective surface 232 to the diffusion surface 22, and light is exported by the diffusion surface 22. A second optical path 26 is directly irradiated by the light source to the diffusion surface 22, and light is exported by the diffusion surface 22. A third optical path 27 is directly irradiated by the light source to the diffusion surface 22, but no light is exported by the diffusion surface 22, then the third optical path 27 is reflected to the reflective surface 232 and then reflected by the reflective surface 232 to the diffusion surface 22, and light is exported by the diffusion surface 22.

Therefore, by using the light guide device of the present invention, light can be fully reflected in the light guide device, and light is exported by the diffusion surface. By disposing the reflective portion and correspondingly disposing the diffusion surface, light directly from the light source or light reflected by the diffusion surface to the reflective portion can be reflected to the diffusion surface through the reflective portion again, so no light will leak to the outside through the reflective portion, thereby greatly increasing light guiding efficiency of the light guide device of the present invention.

According to the first embodiment of the present invention, the light guide device 20 further includes at least one side surface 24, which is disposed between the diffusion surface 22 and the reflective portion 23, and the at least one side surface 24 is a nebulous surface, so that light is mainly exported from the diffusion surface 22, thereby achieving better light guiding effect and visual effect.

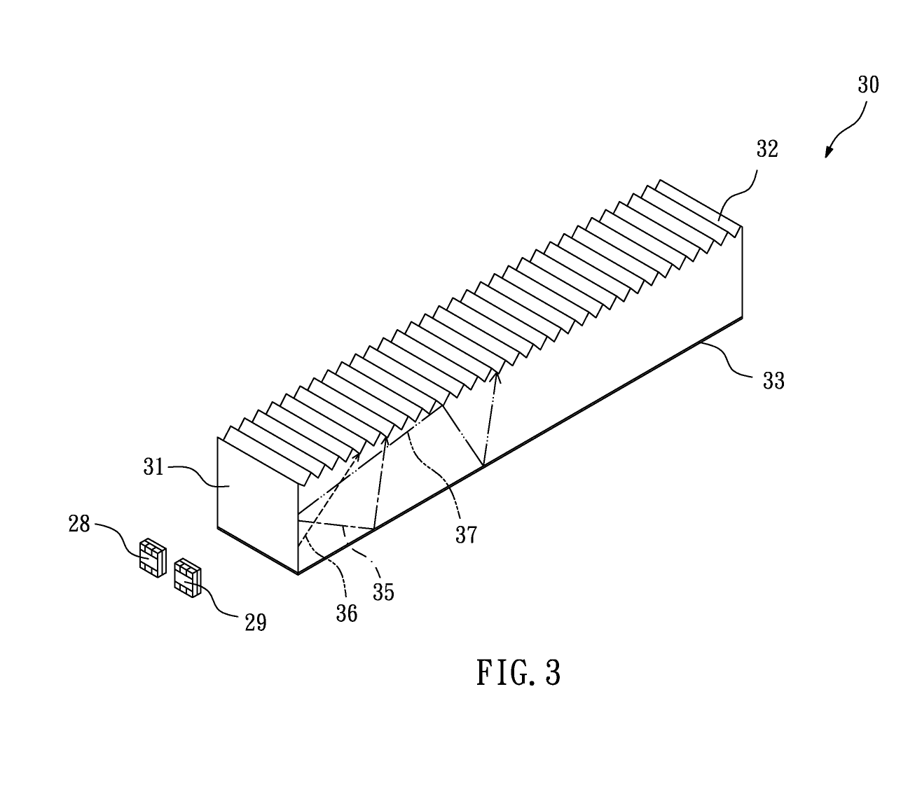

Referring to FIG. 3, it shows a schematic view of a light guide device for vehicle according to a second embodiment of the present invention. According to the second embodiment of the present invention, the light guide device 30 includes: at least one incident portion 31, a diffusion surface 32 and a reflective portion 33. The difference between the light guide device 30 according to the second embodiment and the light guide device 20 according to the first embodiment lies in that, the reflective portion 33 is a plane, and the reflective portion 33 is an electroplating surface. Preferably, the electroplating surface is an electroplating aluminum surface.

Likewise, for example, a first optical path 35 is irradiated by the light source to the reflective portion 33, and reflected by the reflective portion 33 to the diffusion surface 32, and light is exported by the diffusion surface 32. A second optical path 36 is directly irradiated by the light source to the diffusion surface 32, and light is exported by the diffusion surface 32. A third optical path 37 is directly irradiated by the light source to the diffusion surface 32, but no light is exported by the diffusion surface 32, then the third optical path 37 is reflected to the reflective portion 33 and then reflected by the reflective portion 33 to the diffusion surface 32, and light is exported by the diffusion surface 32.

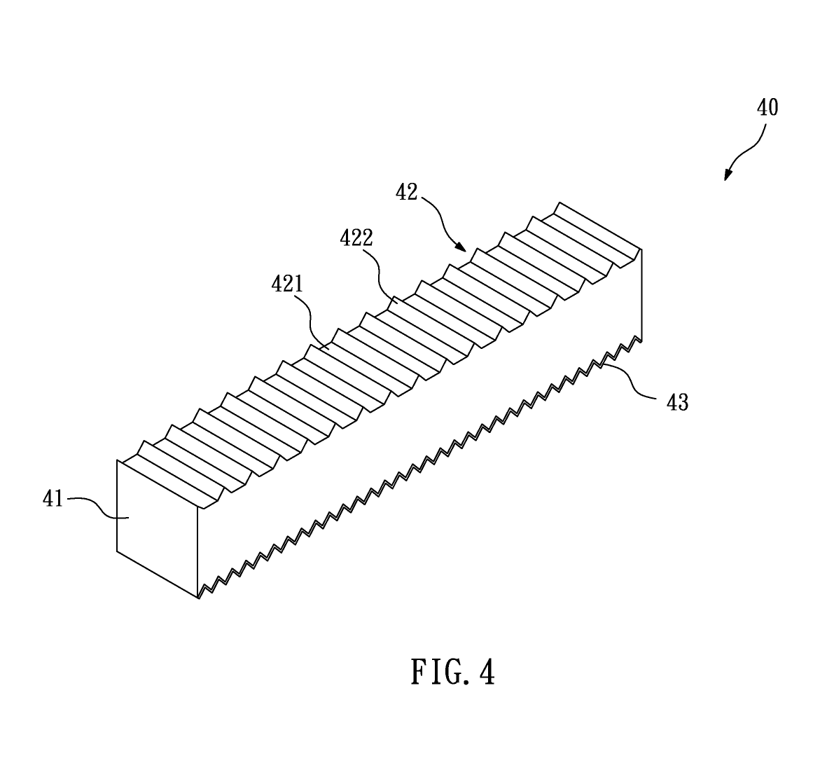

Referring to FIG. 4, it shows a schematic view of a light guide device for vehicle according to a third embodiment of the present invention. According to the third embodiment of the present invention, the light guide device 40 includes: at least one incident portion 41, a diffusion surface 42 and a reflective portion 43. The difference between the light guide device 40 according to the third embodiment and the light guide device 20 according to the first embodiment lies in that, the diffusion surface 42 further includes a plurality of plane portions 421, which are disposed between the zigzag structures 422. In this embodiment, the plane portions 421 and the zigzag structures 422 are evenly and alternately disposed. In other embodiments, the number of the plane portions and the zigzag structures which are alternately disposed can be changed according to design.

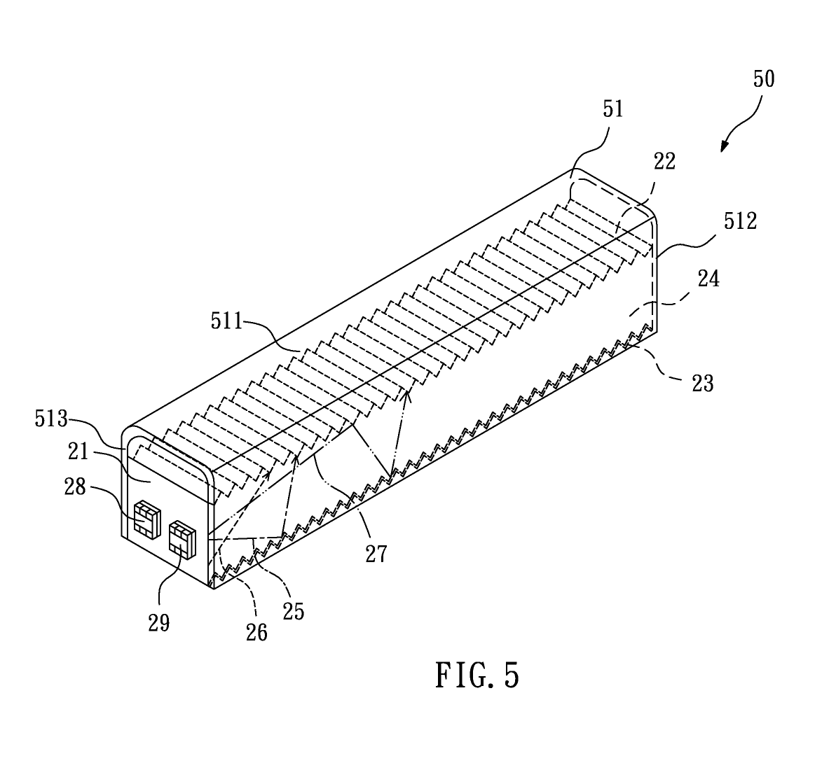

Referring to FIG. 5, it shows a schematic view of a light guide device for vehicle according to a fourth embodiment of the present invention. According to the fourth embodiment of the present invention, the light guide device 50 includes: at least one incident portion 21, a diffusion surface 22, a reflective portion 23 and a cover body 51. The at least one incident portion 21, the diffusion surface 22 and the reflective portion 23 of the light guide device 50 according to the fourth embodiment of the present invention are the same as those of the light guide device 20 according to the first embodiment, which are not described again herein.

The cover body 51 covers the diffusion surface 22, the cover body 51 has a light-emitting surface 511, and light from the diffusion surface 22 is exported by the light-emitting surface 511. In this embodiment, a distance exists between the light-emitting surface 511 and the diffusion surface 22. The cover body 51 further includes two lateral portions 512 and 513, which extend downward from two side edges of the light-emitting surface 511. In this embodiment, the two lateral portions 512 and 513 wrap the side surface 24. Preferably, both the two lateral portions 512 and 513 have nebulous surface, so that light is mainly exported by the light-emitting surface 511.

While several embodiments of the present invention have been illustrated and described, various modifications and improvements can be made by those skilled in the art. The embodiments of the present invention are therefore described in an illustrative but not in a restrictive sense. It is intended that the present invention should not be limited to the particular forms as illustrated and that all modifications which maintain the spirit and scope of the present invention are within the scope defined in the appended claims.

What is claimed is:

1. A light guide device for vehicle, comprising:
at least one incident portion, disposed on at least one end of the light guide device, and for receiving at least one light source;
a diffusion surface, for exporting light, and the diffusion surface having a plurality of zigzag structures; and
a reflective portion, being opposite to the diffusion surface, and for reflecting light to the diffusion surface, wherein the at least one incident portion is disposed between the diffusion surface and the reflective portion.

2. The light guide device according to claim 1, wherein the reflective portion is an electroplating surface.

3. The light guide device according to claim 2, wherein the electroplating surface is an electroplating aluminum surface.

4. The light guide device according to claim 1, wherein the reflective portion comprises a zigzag portion and a reflective surface, the zigzag portion has a plurality of zigzag structures, the reflective surface is formed at surfaces of the zigzag structures, and the reflective surface is an electroplating surface.

5. The light guide device according to claim 1, wherein the diffusion surface further comprises a plurality of plane portions disposed between the zigzag structures.

6. The light guide device according to claim 5, wherein the plane portions and the zigzag structures are alternately disposed.

7. The light guide device according to claim 1, further comprising at least one side surface disposed between the diffusion surface and the reflective portion, and the at least one side surface being a nebulous surface.

8. The light guide device according to claim 1, further comprising a cover body for covering the diffusion surface, the cover body having a light-emitting surface, wherein light from the diffusion surface is exported by the light-emitting surface.

9. The light guide device according to claim 8, wherein the cover body further comprises two lateral portions extending downward from two side edges of the light-emitting surface, both the two lateral portions have nebulous surface.

10. The light guide device according to claim 1, wherein the at least one light source is disposed at the at least one incident portion, and is disposed between the diffusion surface and the reflective portion.
